(19) United States
(12) Patent Application Publication
(10) Pub. No.: US 2004/0188510 A1
(43) Pub. Date: Sep. 30, 2004

(54) System for registry-based automatic installation and component handling on a device

(76) Inventors: Stephen A. Sprigg, Poway, CA (US); Brian Harold Kelley, San Diego, CA (US); Brian Minear, San Diego, CA (US); Robert Walker, San Diego, CA (US)

Correspondence Address: Qualcomm Incorporated, Patents Department, 5775 Morehouse Drive, San Diego, CA, 92121-1714, US

(21) Appl. No.: 10/740,227

(22) Filed: Dec. 18, 2003

Related U.S. Application Data
(60) Provisional application No. 60/435,486, filed on Dec. 20, 2002.
(60) Provisional application No. 60/435,828, filed on Dec. 20, 2002.

(51) Int. Cl. G06F 17/00

(52) U.S. Cl. 235/375

(57) ABSTRACT

System for registry-based automatic installation and component handling on a device. A method is provided for automatically processing a component on a device, where the component has a selected component type. The method includes installing a component handler on the device, where the component handler is operable to process components having the selected component type. The method also includes parsing an action list to obtain a component/action pair that identifies the component to be processed by the device, and downloading the component to the device. The method also includes determining that the component has the selected component type, and using the selected component type to activate the component handler to process the component.

### CROSS-REFERENCE TO RELATED APPLICATIONS

This Application claims the benefit of priority of a pending U.S. Provisional Patent Application entitled “AUTO-INSTALL” having Application No. 60/435,486 and filed on Dec. 20, 2002, the disclosure of which is incorporated by reference herein in its entirety for all purposes.

This Application also claims the benefit of priority of a pending U.S. Provisional Patent Application entitled “REGISTRY-BASED AUTO INSTALL COMPONENT HANDLING” having Application No. 60/435,828 and filed on Dec. 20, 2002, the disclosure of which is incorporated by reference herein in its entirety for all purposes.

### BACKGROUND

I. Field

The present invention relates generally to the processing of components on a device, and more particularly, to a system for registry-based automatic installation and component handling on a device.

II. Description of the Related Art

Data networks provide a way for a large numbers of users to communicate with each other using a variety of network-enabled devices. For example, in a wireless communication network, a variety of network-enabled portable telephones allow users to communicate with each other over great distances. The network-enabled devices are generally configured with a variety of installed components that control how the device operates, and ultimately, how well the overall network performs.

In certain circumstances a network operator would like to upgrade, install, delete, or otherwise change the configuration of the network-enabled devices. For example, as system software is improved, the network operator would like to have new components installed on all devices in the network so that the network operates more efficiently. For example, the network operator may like to install application software, a binary executable, or other information on the devices to provide service improvements or upgrades. In another situation, the network operator may desire to install enterprise applications or other device upgrade applications based on the needs of a specific type of device. Furthermore, if it is determined that a problem exists with a currently installed system component, the network operator would like to install an upgraded component to repair the problem, regardless of whether the device user is even aware that the problem exists. For example, if a problem exists with a current device component that allows a user to view multimedia content, the network operator would like to upgrade all the devices on the network to replace this component with a new component that does not have the problem.

One technique used to install, upgrade, delete, or otherwise change the components on a device is to wait for the device user to return the device to a repair center. Once at the repair center, repair personnel can reprogram the device so that the device has the most recent component versions. Unfortunately, this process is very inefficient because device users may fail to return the device if they are unaware of the problem, or if the problem is not currently affecting how they used the device. Because not all of the devices will be upgraded, some devices will not operate to provide the best performance and the overall operation of the network may be degraded.

Therefore, what is needed is a system to automatically process components on a device to allow selected versions of components to be installed and activated. The system should be flexible enough to process the components on a large number of devices in a relatively short time, thereby providing fast upgrades to all devices operating on a network, which will result in the best device performance and increased network efficiency.

### SUMMARY

In one or more embodiments, a system is provided to automatically process components on a device. For example, in one embodiment, the system allows a device to install, update, delete, activate, disable or otherwise change the state of a component on a device using a versioned action list available on a download server. The components that can be processed may be of any type, for example, an application, executable, configuration information, user interface settings, random data, or any other type of information.

During operation of the system, the device checks the version of the action list on the download server against a stored version associated with the last action list processed by the device. If the two versions are different, the device downloads the new action list from the server and parses each item in the action list to process components on the device. In one embodiment, each item in the action list comprises a component/action pair that associates a component identifier with an action identifier. The component identifier identifies a type of component and its current version. The action identifier identifies an action to be performed by the device with respect to the identified component.

In one embodiment, the device parses each component/action pair in the action list to determine whether an action needs to be performed for the identified component. The device compares the version of the component in the action list to a component version stored on the device. If the two component versions are the same, the device takes no action with regards to that component/action pair. If the versions are different, the device performs the action associated with the component in the action list to change the state of the component on the device. For example, if the action is to install the identified component, the device downloads the component, and any other necessary information from the download server, and installs the component on the device. Thus, the device steps through the action list performing the designated actions only on new component versions.

After processing a particular component/action pair, the component version stored on the device is updated with the new component version provided in the action list. When the entire action list has been processed, the device records the version identifier of the action list, so as to avoid re-processing the current action list in the future. Thus, the device will not process another action list until the version of the action list available on the download server is different from the stored version on the device.

In one embodiment, the device checks the version of the action list every time the device communicates with the download server. For example, the device may communicate with the download server after the device is powered on or at periodic intervals. The system provides a mechanism to allow components to be processed on the device with no user interaction or limited user interaction. For example, in one embodiment, components may be pushed to a device at power up to effectively provide a “silent installation.” In another embodiment, a user interface is provided so that the component processing may be at the option of the user. Thus, the system allows the component processing to be forced, prompted, required, or optional.

The system may be used to process components on a single device or on a large number of devices. For example, in a data network where are large number of devices can access an action list server, a single action list can be delivered to all devices and each device can determine what components to process for that device. In another embodiment, the server may provide multiple action lists that can be used for different device types. For example, different types of devices may access a different action list to process components for that type of device. Thus, it is possible for the system to provide global updates to a large number of devices, where the updates are performed over a period of hours or days as each device contacts the action list server. Additionally, communication between the server and a device can be performed using any type of secure communication technique, such as encryption or any type of encoding, so that the devices can be authenticated and any transmission of information is done in a secure fashion.

In one embodiment, the system provides the ability to add device support for components based on a component type. A component “handler” is provided that is designed to process a component having a specific component type (i.e., a specific “Multipurpose Internet Mail Extension” (MIME) type). The handler is an application or executable that will save and commit the component's data. For example, the system may operate to download and install a component handler that is designed to process components having a selected MME type. In one embodiment, the component handler is registered in the device's operating system registry. Once the handler is installed, the system may download a component having the selected type, and the associated handler will be activated to process the component. Thus, the component handlers are not embedded in the operating system layers, and therefore may be provided by an OEM, or provided by a third party and/or downloaded/upgraded dynamically. This allows not only new component types to be processed on the device post-production, but also new mechanisms to handle the new component types as well.

In one embodiment, a method is provided for automatically processing a component on a device, where the component has a selected component type. The method comprises installing a component handler on the device, where the component handler is operable to process components having the selected component type. The method also comprises parsing an action list to obtain a component/action pair that identifies the component to be processed by the device, and downloading the component to the device. The method also comprises determining that the component has the selected component type, and using the selected component type to activate the component handler to process the component.

In one embodiment, apparatus is provided for automatically processing a component on a device, wherein the component has a selected component type. The apparatus comprises logic to install a component handler on the device, where the component handler is operable to process components having the selected component type. The apparatus also comprises logic to parse an action list to obtain a component/action pair that identifies the component to be processed by the device, and logic to download the component to the device. The apparatus also comprises logic to determine that the component has the selected component type, and logic to use the selected component type to activate the component handler to process the component.

In one embodiment, apparatus is provided for automatically processing a component on a device, where the component has a selected component type. The apparatus comprises means for installing a component handler on the device, where the component handler is operable to process components having the selected component type. The apparatus also comprises means for parsing an action list to obtain a component/action pair that identifies the component to be processed by the device, and means for downloading the component to the device. The apparatus also comprises means for determining that the component has the selected component type, and means for using the selected component type to activate the component handler to process the component.

In one embodiment, a computer-readable media is provided that comprises instructions, which when executed by processing logic in a device, operate to automatically process a component on the device, where the component has a selected component type. The computer-readable media comprises instructions for installing a component handler on the device, where the component handler is operable to process components having the selected component type. The computer-readable media also comprises instructions for parsing an action list to obtain a component/action pair that identifies the component to be processed by the device, and instructions for downloading the component to the device. The computer-readable media also comprises instructions for determining that the component has the selected component type, and instructions for using the selected component type to activate the component handler to process the component.

Other aspects, advantages, and features of the present invention will become apparent after review of the hereinafter set forth Brief Description of the Drawings, Detailed Description of the Invention, and the Claims.

### BRIEF DESCRIPTION OF THE DRAWINGS

The foregoing aspects and the attendant advantages of the embodiments described herein will become more readily apparent by reference to the following detailed description when taken in conjunction with the accompanying drawings wherein:

FIG. 1 shows one embodiment of a system to automatically process components on a device;

FIG. 2 shows a functional diagram of a device that includes one embodiment of a system to automatically process components;

FIG. 3 shows one embodiment of a method for operating a device to provide a system to automatically process components on the device;

FIG. 4 shows one embodiment of a method for operating a device to process component handlers designed to operate on specific component types;

FIG. 5 shows one embodiment of a method for operating a device to process component handlers designed to operate on specific component types;

FIG. 6 shows transactions that occur between a download server and a device during operation of one embodiment of a system to automatically process components on the device; and

FIG. 7 shows one embodiment of an action list for use in a system to automatically process components on a device.

### DETAILED DESCRIPTION

The following detailed description describes embodiments of a system to automatically process components on a device. The system is suitable for use in any type of wired or wireless network, including but not limited to, communication networks, public networks, such as the Internet, private networks, such as virtual private networks (VPN), local area networks, wide area networks, long haul network, or any other type of data network. The system is also suitable for use with any type of device that is capable of downloading and installing components. For example, the system is suitable for use with office computers, notebook computers, and handheld devices, such as portable telephones, PDAs, or any other type of device capable of receiving and installing components.

In one or more embodiments, the system interacts with a runtime environment executing on the device that is used to simplify operation of the device, such as by providing generalized calls for device specific resources. One such runtime environment is the Binary Runtime Environment for Wireless™ (BREW™) software platform developed by QUALCOMM, Inc., of San Diego, Calif. In the following description, it will be assumed that the device is executing a runtime environment, such as the BREW software platform. However, one or more embodiments of the system are suitable for use with other types of runtime environments to automatically process components on a variety of wired and wireless devices.

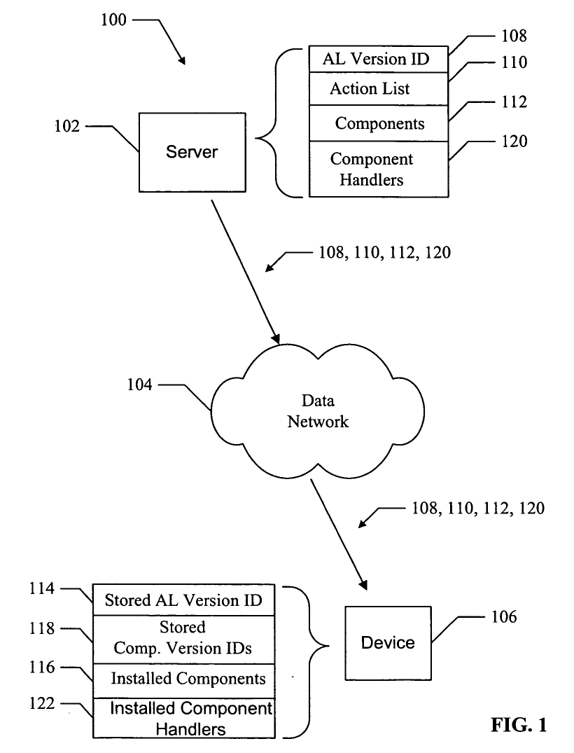

FIG. 1 shows one embodiment of a system 100 to automatically process components on a device. The system 100 comprises a server 102, a data network 104, and a device 106. The data network 104 may be any type of wired or wireless network that allows information to be communicated between the server 102 and the device 106. For example, the network 104 may be a communication network, wide area network, virtual private network, or a public network, such as the Internet.

In one or more embodiments, the system operates to process components on the device 106. For example, the server 102 includes components 112, an action list 110, an action list version identifier 108, and component handlers 120. The version identifier 108 identifies the current version of the action list 110. The action list 110 comprises component/action pairs where each pair comprises a component identifier and an action identifier. The component identifier is a unique item ID that identifies a particular component. A portion of the component identifier is used to identify a version of the component. For example, the component identifier is a series of bits where a portion of the bits is used to identify the version of the component. The action identifier identifies a particular action, such as install, update, delete, recall, disable, or any other action that the device 106 will perform with regards to the identified component.

The component handlers 120 are designed to process selected component types. For example, in one embodiment, the component handlers are designed to process components having selected MIME types. The component handlers can be installed on the device 106 and registered in the device's operating system registry. Once installed, the component handlers are activated to process components having corresponding format types.

During operation, the server 102 transmits the action list version identifier 108 to the device 106 via the network 104. For example, the device 106 may contact the server 102 during a power up sequence and the server 102 responds by transmitting the action list version identifier 108 to the device 106. In another embodiment, the server 102 contacts the device 106 when a new version of the action list is available for download. For example, in one embodiment, when a new action list becomes available, the server 102 sends a message to the device 106 that includes the action list version identifier 108. The device 106 compares the version identifier 108 with a stored version identifier 114 that represents the version of the last action list to be processed by the device 106. If the downloaded version 108 and the stored version 114 are equivalent, then the device does not need to perform any installations or changes to the existing components 116 on the device. However, if the downloaded version 108 is different from the stored version 114, then the device 106 knows that additional component processing is required. For example, there may be new components located at the server 102 that need to be installed on the device 106.

Once the device 106 detects that a new version of the action list exists, it transmits a request to the server 102 to obtain the new action list 110. The server 102 responds by transmitting the action list 110 to the device 106. The device 106 then processes the action list 110 to install, update, delete or otherwise process components identified in the action list 110.

The device 106 operates to process the action list 110 by stepping through each component/action pair and determining whether or not to take action with regard to each component. For example, if the action list specifies that a component needs to be installed or updated, the device 106 downloads the component 112 and any other required files from the server 102 and installs it on the device 106. If the action list 110 specifies that a component needs to be deleted, the device 106 deletes the component. Thus, each component/action pair in the action list 110 is processed by the device 106 to automatically install, update, delete, etc., the identified component. The action list may be of any length and after processing the action list, the device 106 updates the stored action list version identifier 114 to store the version of the most recently processed action list.

In one embodiment, the device 106 parses the component/action pairs in the action list 110 to determine whether or not action related to a particular component needs to be taken. For example, the device 106 may already have the newest version of a component installed, and so it is not necessary for the device to re-install that component. In one embodiment, the component identifier in the action list 110 includes information to determine the version of the component. For example, the version information can be appended to the end of the component identifier. The device 106 compares a stored component version 118 to the component version downloaded in the action list 110. If the stored and downloaded component versions are the same, then the device need not take any action with regards to that component. However, if the stored and downloaded component versions are different, then the device 106 performs the action associated with that component in the action list. Thus, the system is very efficient, since the device 106 only processes new versions of the components.

In one embodiment, the action list comprises a component/action pair that identifies a particular component handler 120 to be installed on the device 106. The component handler 120 is a program that is designed to process components having a specific component type. For example, the component type may be a MIME type that identifies the format of a file. In one embodiment, the component type may be provided as a string of characters added to the beginning of the component file. In essence, the component type defines the way the component's data is to be handled.

In response to parsing the component/action pair, the device downloads the component handler 120 from the server 102 and installs the component handler 120 as part of the device's installed component handlers 122. When the component handler 120 is installed in the device 106, it is registered in the device's operating system registry so that it will be activated to process components having the corresponding component type. For example, the operating system registry identifies what handler will be used to handle certain component types, such as URLs, documents, images, or other data files.

After the component handler 120 is installed on the device 106, the component handler 120 operates to process any components that have the selected component type. In one embodiment, the system operates to install a component handler to handle a component that is not yet installed. For example, the system performs the following steps to automatically process components on a device.

1. Install a component handler on the device to process a specific component type.

2. Download a data component to the device that has the specific component type.

3. Process the data component using the component handler.

Thus, the system operates to allow new versions of components to be downloaded from the server 102 and processed on the device 106. The components may comprise component handlers that operate to process selected component types. To process a new component type on the device, a new component handler is first installed in the operating system registry, and thereafter activated to process the new component.

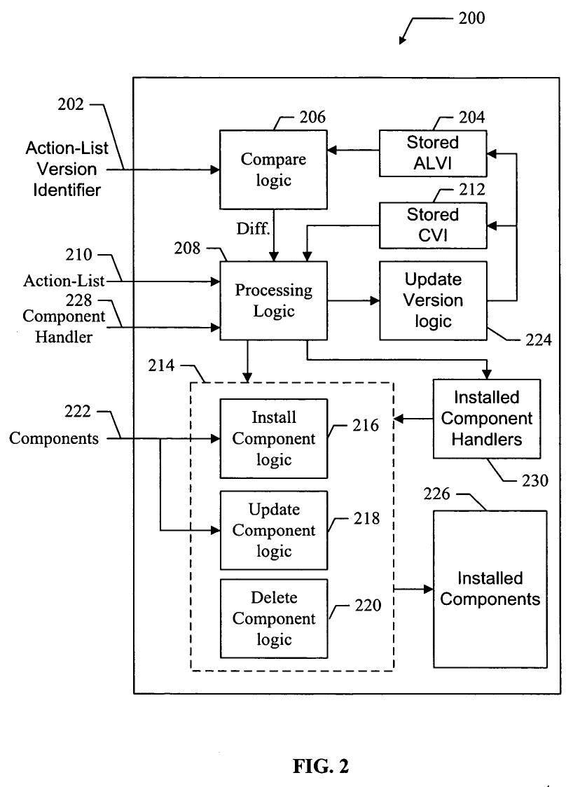

FIG. 2 shows a functional diagram of a device 200 that includes one embodiment of a system to automatically process components on the device 200. The device comprises processing logic 208, compare logic 206, function logic 214, version update logic 224, a stored action list version identifier (ALVI) 204 and component version identifiers (CVI) 212, installed component handlers 230, and installed components 226. The described logic and functions provided by the device 200 may be implemented in hardware, software, or a combination of hardware and software. For example, in one or more embodiments, the functional elements shown in FIG. 2 comprises a CPU, processor, gate array, hardware logic, memory elements, virtual machine, software, and/or any combination of hardware and software. Thus, the processing logic 208 generally comprises logic to execute machine-readable instructions to perform the functions described herein. It should be noted that the device 200 illustrates just one embodiment and that changes, additions, or rearrangements of the device elements may be made without deviating from the scope of the invention.

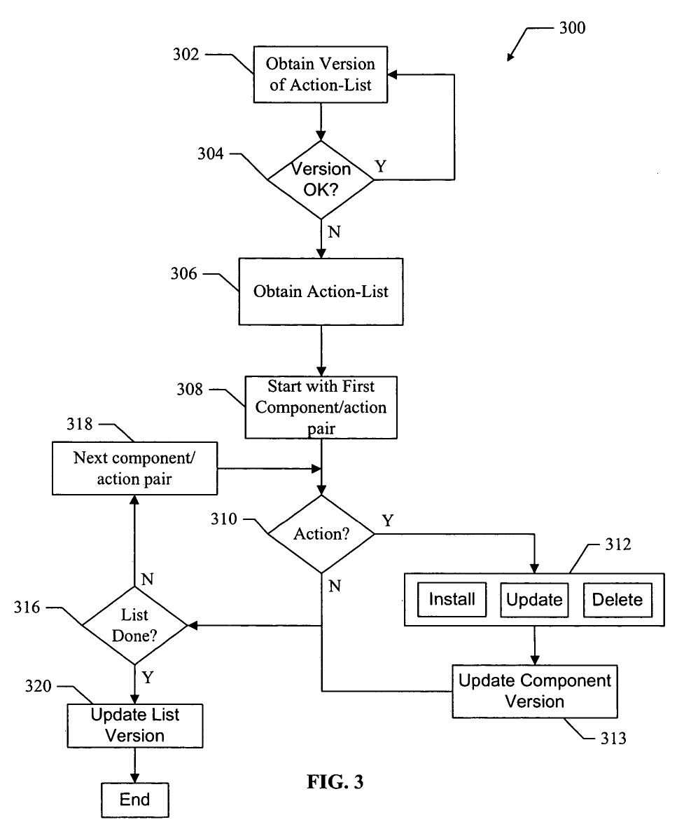

FIG. 3 shows one embodiment of a method 300 for operating a device, such as device 200, to provide a system to automatically process components on the device 200. For the purposes of clarity, the method 300 will be described with reference to the device 200 shown in FIG. 2. It will further be assumed that the device 200 is in secure communication with a download server via a data network, as illustrated in FIG. 1.

At block 302, the device obtains an action list version identifier from the download server. For example, the device communicates with the download server via a data network and the download server transmits the action list version identifier to the device, as shown at 202.

At block 304, a test is performed to determine if the downloaded action list version identifier is different from a stored version identifier that is associated with the last action list to be processed by the device. For example, the downloaded version identifier 202 and the stored version identifier 204 are input to compare logic 206 that compares the two identifiers to determine if they are equivalent. If the two version identifiers are equivalent, the method returns to block 302 to obtain a new version of the action list at another time. If the two version identifiers are different (Diff), the method proceeds to block 306.

At block 306, the device retrieves the action list from the download server. For example, the action list 210 is downloaded from the server to the processing logic 208 via the data network.

At block 308, the device begins processing the action list by parsing the first component/action pair in the action list. For example, the processing logic 208 operates to process the downloaded action list 210 to parse the component/action pairs.

At block 310, a test is performed to determine what action, if any, is required for the component/action pair that is currently being processed. In one embodiment, the device operates to automatically perform the action by proceeding to block 312. However, this may result in existing components being re-installed on the device. In another embodiment, the version of the component is checked to determine if the action is necessary. For example, if the action is to “install” the component, the version of the component is checked to see if the device has that version of the component currently installed. Thus, the method operates to avoid re-installing components that are already installed on the device. For example, the processing logic 208 retrieves a stored component version identifier 212 and compares it to the version of the component identified in the action list. In one embodiment, the version of the component is incorporated in the component identifier provided in the action list. If the two component versions are the same, no further action is required with regards to that component and the method proceeds to block 416. If the two component versions are different, then the processing logic 208 operates to perform the action associated with the component and the method proceeds to block 312.

At block 312, the action associated with the component in the current component/action pair is performed to change the state of the identified component. For example, the processing logic 208 operates to control the action logic 214 to perform the action of installing, updating, deleting, activating, disabling, recalling or otherwise changing the state of the identified component. For example, a soft recall may be performed where the component is deleted from the device but associated data and/or licensing information is not removed. For example, if the action is to install or update the component, the processing logic 208 operates to download the component 222 (or update) from the download server via the data network. The downloaded component is then installed as an installed component 226. The processing logic 208 may perform any type of installation or update procedure to install or update the downloaded component 222 as an installed component 226. If the action is to delete a component, the processing logic 208 controls the delete logic 220 to delete the identified component from the installed components 226. Although not shown in FIGS. 2 and 3, virtually any type of action may be performed with regards to the component, such as installing, updating, deleting, recalling, activating, deactivating, or otherwise changing the state of the component on the device.

At block 314, a component version list is updated to reflect that a new version of the component has been installed or updated, or that the component has been deleted.

For example, the processing logic 208 controls the version update logic 224 to update the stored component version identifiers 212 with the new information about the currently processed component.

At block 316, a test is performed to determine if all of the component/action pairs in the action list have been processed. If all pairs have been processed, the method proceeds to block 320. If all pairs have not been processed, the method proceeds to block 318 where the next pair is accessed for processing at block 310. The action list 210 may be any length and so there may exist any number of component/action pairs to be processed.

At block 320, the stored action list version identifier at the device is updated. For example, the processing logic 208 controls the update version logic 224 to update the stored action list version identifier 204 with the identifier associated with the most recently processed action list. Thus, the system will not operate to process another action list until a new version of the action list is available.

In one embodiment, the system for automatically processing components on the device comprises program instructions stored on a computer-readable media, which when executed by the processing logic 208, provides the functions described herein.

For example, instructions may be loaded into the device 200 from a computer-readable media, such as a floppy disk, CDROM, memory card, FLASH memory device, RAM, ROM, or any other type of memory device or computer-readable media that interfaces to the device 200. In another embodiment, the instructions may be downloaded into the device 200 from a network resource that interfaces to the device 200 via a data network. The instructions, when executed by the processing logic 208, provide one or more embodiments of a system for automatically processing components on the device as described herein.

It should be noted that the method 300 illustrates just one embodiment and that changes, additions, or rearrangements of the method elements may be made without deviating from the scope of the invention.

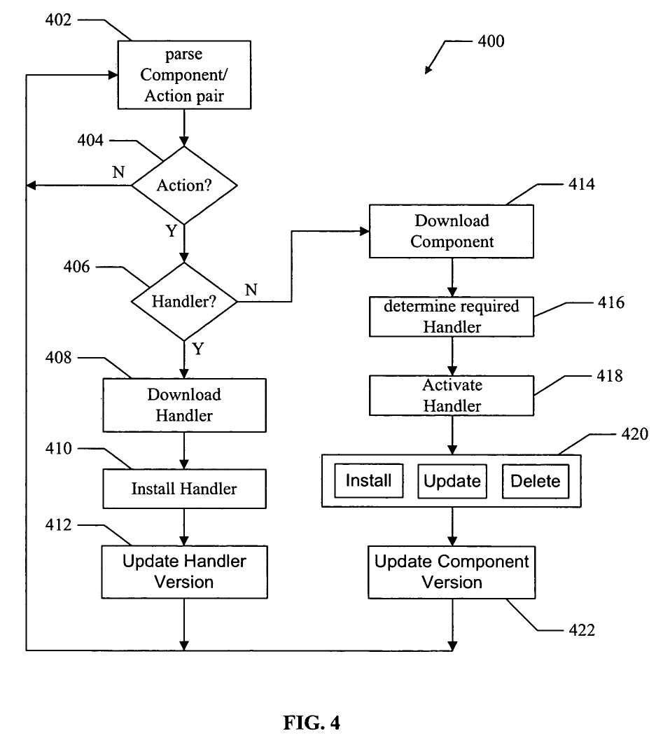

FIG. 4 shows one embodiment of a method 400 for operating a device to process component handlers designed to operate on specific component types. For the purposes of clarity, the method 400 will be described with reference to the device 200 shown in FIG. 2. It will be assumed that the method 300 is used to download an action list and process components as described above. The method 400 further describes how the system operates to process components that are component handlers designed to operate on specific component types. In one or more embodiments, the following method steps are performed by the processing logic 208 during execution of program instructions.

At block 402, the system parses a component/action pair obtained from a downloaded action list. For example, the action list may have been obtained as described with regards to block 306 of FIG. 3.

At block 404, a test is performed to determine if any action need be taken with regards to the component/action pair. For example, the version of the component in the component/action pair is compared to a stored component version, and if the two versions are different, then the corresponding action will be taken with regards to the identified component.

At block 406, assuming some action is to be taken; a test is performed to determine if the identified component is a component handler. A component handler is a program designed to operate on a selected component type. If the component is determined to be a component handler, the method proceeds to block 408.

At block 408, the identified component handler is downloaded to the device. For example, the component handler 228 may be downloaded from a server, such as server 102.

At block 410, the component handler is installed on the device. For example, the component handler is registered in the device's operating system registry as an application that operates on components having a specific component type. In one embodiment, the operating system's registry is part of the processing logic 208. After registration, the component handler 228 becomes part of the installed component handlers 230 on the device 200.

At block 412, the version identifier of the installed component handler is updated in the stored component version identifier list located on the device. For example, the update version logic 224 updates the stored component version identifiers 212 with the version of the recently installed component handler 228. The method 400 then proceeds to block 402 to parse the next component/action pair.

It will be assumed for the following description that blocks 402 and 404 parse a subsequent component/action pair that identifies a component to be processed on the device.

At block 406, a test is performed to determine if the identified component is a component handler. If the component is not a component handler, the method proceeds to block 414.

At block 414, the component is downloaded to the device. For example, the processing logic 208 downloads the component from a server (shown generally at 222).

At block 416, the format type of the component is determined. For example, the component may have a selected MIME type of other formatting that indicates the format of the information in the component and/or how that information should be processed.

At block 418, a component handler associated with the component type is activated to process the component. For example, the operating system registry is used to determine which component handler should be used to process the selected component type. The handler identified by the registry is activated to process the component. For example, the processing logic 208 activates one of the installed component handlers 230 to process the component.

At block 420, the activated component handler processes the component. For example, the component handler may operate to install, delete, update, activate, merge data, or otherwise change the state of the component on the device.

At block 422, the component version identifier stored on the device is updated with the new component version. For example, the update version logic 224 updates the component version identifiers 212 stored on the device. The method then proceeds to process the next component/action pair at block 402.

Therefore, the method 400 operates to download and install a component handler that is subsequently used to process a downloaded component. The handler is designed to process a specific component type, and when installed, it is registered in the device's registry. When a component having the specific type is to be processed on the device, the registry is used to activate the handler to perform the required processing on the component. The component version identifier on the device is then updated.

In another embodiment, the component handler 228 and the associated component are downloaded to the device 200 using different action lists. For example, a first action list is used to download and install the component handler, and a second action list is used to process the component, where the previously installed component handler processes the component.

In another embodiment, the component handler 228 is installed on the device 200 using any other installation technique. For example, the component handler may be installed using a separate transmission from the download server, or the component handler may be installed from a local system or device. However, once the component handler is installed, it is registered in the operating system registry and used to process the corresponding component.

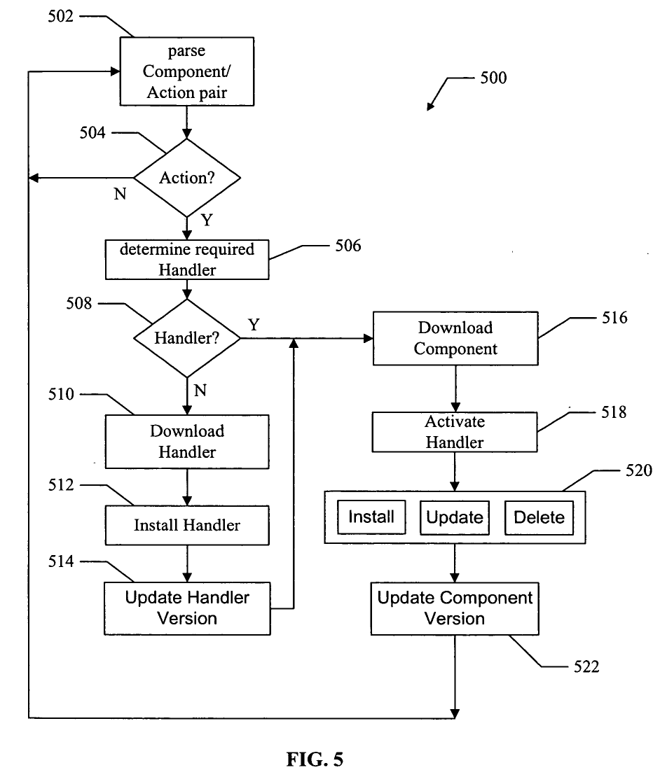

FIG. 5 shows one embodiment of a method 500 for operating a device to process component handlers designed to operate on specific component types. For the purposes of clarity, the method 500 will be described with reference to the device 200 shown in FIG. 2. It will be assumed that the method 300 is used to download an action list and process components as described above. The method 500 further describes how the system operates to process component handlers designed to operate on specific component types. In one or more embodiments, the following method steps are performed by the processing logic 208 during execution of program instructions.

At block 502, an action list is parse to obtain a component/action pair to be processed on the device. At block 504, a test is performed to determine if any action is required with respect to the identified component. If action is required to change the state of the identified component on the device, the method proceeds to block 506.

At block 506, the component handler required to process the component is determined. For example, in one embodiment, the component identifier in the action list includes a “type” identifier that identifies the type of component. The processing logic 208 uses the “type” indicator to determine a component handler that is required to process the component.

At block 508, a test is performed to determine if the required component handler currently exists on the device. For example, the processing logic 208 checks the installed component handlers 226 to determine if the required handler is installed. If the required handler is installed, the method proceeds to block 516. If the required handler is not installed, the method proceeds to block 510.

At block 510, the required component handler is downloaded to the device. For example, in one embodiment, the processing logic 208 downloads the component handler 228 from a download server. Any technique may be used to download the component handler to the device.

At block 512, the handler is installed on the device. For example, the handler is registered in the operating system registry so that it can be activated to process selected component types. At block 514, the stored version of the handler is updated. For example, the update version logic 224 updates the stored component versions identifiers 212. The method then proceeds to block 516.

At block 516, the identified component is downloaded to the device. For example, the processing logic 208 downloads the identified component from a download server.

At block 518, the newly installed handler is activated to process the downloaded component. For example, the processing logic 208 uses the registry to determine which of the installed component handlers 230 to activate to process the component. As a result, the newly installed component handler will be activated to process the component.

At block 520, the component handler processes the component on the device to change the state of the component on the device. For example, the component handler may operate to install, delete, update, activate, merge data, or otherwise change the state of the component on the device.

At block 522, the stored version identifier of the component is updated. For example, the update version logic 224 updates the stored component version identifiers 212. The method then proceeds to block 502 to parse another component/action pair.

Therefore, the method 500 operates to determine whether a required component handler is available to process a component. If the component handler is not installed on the device, the handler is downloaded from a download server, installed, and subsequently used to process a downloaded component. The handler is designed to process a specific component type, and when installed, it is registered in the device's registry. When a component having the specific type is to be processed on the device, the registry is used to activate the correct handler to perform the required processing on the component. The component version identifier on the device is then updated.

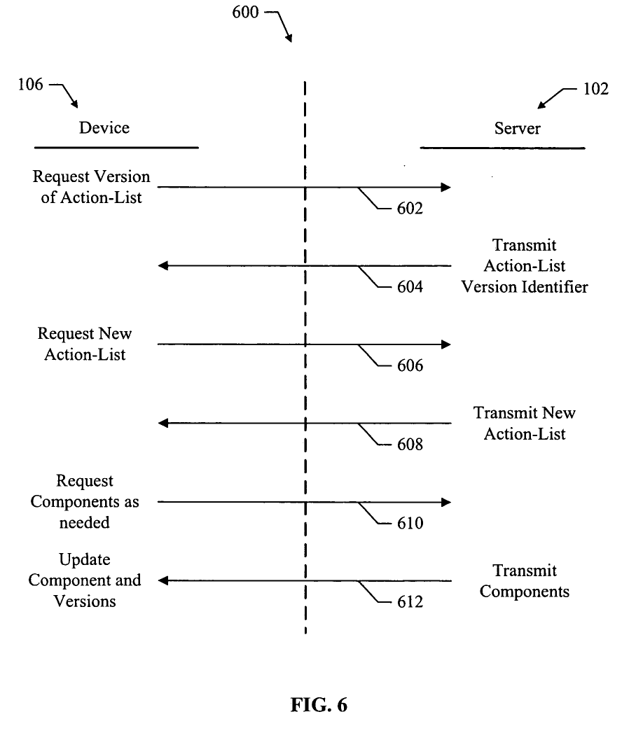

FIG. 6 shows transactions 600 that occur between a download server and a device during operation of one embodiment of a system to automatically process components on the device. For example, the transaction 600 may occur between the device 106 and the server 102 shown in FIG. 1.

At the start of the automatic process, the device 106 requests the latest version identifier of an action list from the server 102, as shown at 602. The action list comprises component/action pairs that describe an action the device should perform with respect to each identified component. The action list may be changed or updated periodically and the action list version identifier identifies the current version of the action list.

The server 102 responds to the request from the device 102 by transmitting the version identifier of the current action list, as shown at 604. After receiving the action list version identifier, the device compares that identifier with a stored action list version identifier. If the two version identifiers are equivalent, then the device takes no further action. If the two version identifiers are different, then the device 102 requests a new action list from the server 102, as shown at 606.

The server 102 responds to the request from the device 106 by transmitting the new action list, as shown at 608. The device 106 processes each component/action pair in the action list to determine whether or not to install, update, delete, or otherwise change the state of a particular component. If the device 106 determines that a particular component needs to be processed, the device 106 requests the component (or update) from the server 102 as shown at 610.

The server 102 responds to the request by transmitting the requested component to the device 106. The device 106 receives the component and processes the component as required. The component may have a component version identifier that the device stores locally. That component version identifier is updated after the device processes the component. After the device 106 parses the entire action list and retrieves all the needed components from the server 102 as necessary, the device 106 updates a locally stored action list version identifier with the version of the action list that was just processed. Thus, the device 106 will not process another action list from the server 102 until the action list version identifier downloaded from the server is different from the stored identifier.

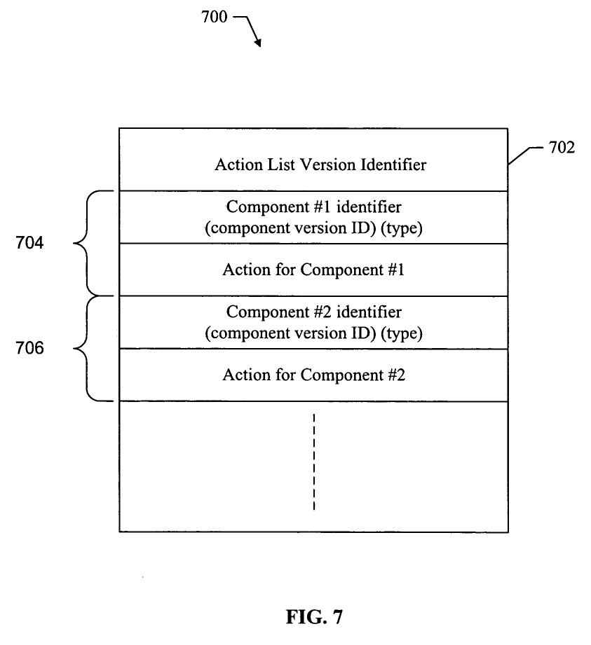

FIG. 7 shows one embodiment of an action list 700 for use in a system to automatically process components on a device. The action list 700 comprises an action list version identifier 702 followed by component/action pairs (704, 706). For example, component/action pair 704 comprises a component identifier and a corresponding action. In one embodiment, the component identifier also includes a component version identifier and a “type” identifier. The version identifier is used so that the version of the component can be used to determine whether or not the component currently exists on the device. The type identifier is used to indicate the type of component, and to determine what handler is required to process the component. The action may be one of install, update, delete, or any other type of action to change the state of the component on the device. The information in the action list may be encoded using any suitable format for secure transmission and/or authentication, and the component and action identifiers may be of any type. In one embodiment, the pair 704 identifies a component handler to be installed on the device, and the pair 706 identifies a component to be processed by the component handler.

Accordingly, while one or more embodiments of a system to automatically process components on a device have been illustrated and described herein, it will be appreciated that various changes can be made to the embodiments without departing from their spirit or essential characteristics. Therefore, the disclosures and descriptions herein are intended to be illustrative, but not limiting, of the scope of the invention, which is set forth in the following claims.

We claim:

1. A method for automatically processing a component on a device, wherein the component has a selected component type, the method comprising:
installing a component handler on the device, wherein the component handler is operable to process components having the selected component type;
parsing an action list to obtain a component/action pair that identifies the component to be processed by the device;
downloading the component to the device;
determining that the component has the selected component type; and
using the selected component type to activate the component handler to process the component.

2. The method of claim 1, wherein the step of installing comprises:
receiving the action list at the device; and
parsing the action list to obtain a selected component/action pair that identifies the component handler.

3. The method of claim 1, wherein the step of installing comprises:
identifying the component handler from the selected component type; and
downloading the component handler to the device.

4. The method of claim 1, wherein the step of installing comprises registering the selected component handler in a device registry.

5. The method of claim 1, wherein the step of using comprises using the selected component handler to change the state of the component on the device.

6. The method of claim 1, wherein the step of using comprises installing the component on the device using the component handler.

7. The method of claim 1, further comprising updating a stored component version identifier with a version identifier associated with the component.

8. The method of claim 1, wherein the device is a wireless device.

9. Apparatus for automatically processing a component on a device, wherein the component has a selected component type, the apparatus comprising:
logic to install a component handler on the device, wherein the component handler is operable to process components having the selected component type;
logic to parse an action list to obtain a component/action pair that identifies the component to be processed by the device;
logic to download the component to the device;
logic to determine that the component has the selected component type; and
logic to use the selected component type to activate the component handler to process the component.

10. The apparatus of claim 9, wherein the logic to install comprises:
logic to receive the action list at the device; and
logic to parse the action list to obtain a selected component/action pair that identifies the component handler.

11. The apparatus of claim 9, wherein the logic to install comprises:
logic to identify the component handler from the selected component type; and
logic to download the component handler to the device.

12. The apparatus of claim 9, wherein the logic to install comprises logic to register the selected component handler in a device registry.

13. The apparatus of claim 9, wherein the logic to use comprises logic to use the selected component handler to change the state of the component on the device.

14. The apparatus of claim 9, wherein the logic to use comprises logic to install the component on the device using the component handler.

15. The apparatus of claim 9, further comprising logic to update a stored component version identifier with a version identifier associated with the component.

16. The apparatus of claim 9, wherein the device is a wireless device.

17. Apparatus for automatically processing a component on a device, wherein the component has a selected component type, the apparatus comprising:
means for installing a component handler on the device, wherein the component handler is operable to process components having the selected component type;
means for parsing an action list to obtain a component/action pair that identifies the component to be processed by the device;
means for downloading the component to the device;
means for determining that the component has the selected component type; and
means for using the selected component type to activate the component handler to process the component.

18. The apparatus of claim 17, wherein the means for installing comprises:
means for receiving the action list at the device; and
means for parsing the action list to obtain a selected component/action pair that identifies the component handler.

19. The apparatus of claim 17, wherein the means for installing comprises:
means for identifying the component handler from the selected component type; and
means for downloading the component handler to the device.

20. The apparatus of claim 17, wherein the means for installing comprises means for registering the selected component handler in a device registry.

21. The apparatus of claim 17, wherein the means for using comprises means for using the selected component handler to change the state of the component on the device.

22. The apparatus of claim 17, wherein the means for using comprises means for installing the component on the device using the component handler.

23. The apparatus of claim 17, further comprising means for updating a stored component version identifier with a version identifier associated with the component.

24. The apparatus of claim 17, wherein the device is a wireless device.

25. A computer-readable media comprising instructions, which when executed by processing logic in a device, operate to automatically processing a component on the device, wherein the component has a selected component type, the computer-readable media comprising:
instructions for installing a component handler on the device, wherein the component handler is operable to process components having the selected component type;
instructions for parsing an action list to obtain a component/action pair that identifies the component to be processed by the device;
instructions for downloading the component to the device;
instructions for determining that the component has the selected component type; and
instructions for using the selected component type to activate the component handler to process the component.

26. The computer-readable media of claim 25, wherein the instructions for installing comprise:
instructions for receiving the action list at the device; and
instructions for parsing the action list to obtain a selected component/action pair that identifies the component handler.

27. The computer-readable media of claim 25, wherein the instructions for installing comprise:
instructions for identifying the component handler from the selected component type; and
instructions for downloading the component handler to the device.

28. The computer-readable media of claim 25, wherein the instructions for installing comprise instructions for registering the selected component handler in a device registry.

29. The computer-readable media of claim 25, wherein the instructions for using comprise instructions for using the selected component handler to change the state of the component on the device.

30. The computer-readable media of claim 25, wherein the instructions for using comprise instructions for installing the component on the device using the component handler.

31. The computer-readable media of claim 25, further comprising instructions for updating a stored component version identifier with a version identifier associated with the component.

32. The computer-readable media of claim 25, wherein the device is a wireless device.
